(19) United States
(12) Patent Application Publication
(10) Pub. No.: US 2014/0171246 A1
(43) Pub. Date: Jun. 19, 2014

(54) LOW-FRICTION ARTICULATED BUSHING CHAIN

(71) Applicant: iwis motorsysteme GmbH & Co. KG, Munchen (DE)

(72) Inventor: Andreas RITZ, Munchen (DE)

(21) Appl. No.: 14/104,928

(22) Filed: Dec. 12, 2013

(30) Foreign Application Priority Data
Dec. 13, 2012 (DE) 102012024395.2

(51) Int. Cl. F16G 13/06

(52) U.S. Cl. CPC F16G 13/06
USPC 474/206

(57) ABSTRACT

An articulated bushing chain comprises inner and outer chain links alternately connected to each other by a chain joint, the inner chain link comprising at least one inner plate and two joint bushings and the outer chain link comprising at least two outer plates and two joint pins interconnecting the same, each chain joint being defined by a joint bushing of the inner chain link and a joint pin of the outer chain link and the chain joint being configured as a rocker joint in which a rocking surface of the joint pin rolls on a convex inner rocker contour of the joint bushing during a movement of the joint. The rocking surface of the joint pin has a rocking radius larger than a limit value calculated according to a given formula. The rocking surface of the joint pin is prevented from slipping on the rocker contour of the joint bushing.

### CROSS-REFERENCE TO RELATED APPLICATION

This application claims priority to foreign German patent application No. DE 102012024395.2, filed on Dec. 13, 2012, the disclosure of which is incorporated by reference in its entirety.

### FIELD OF THE INVENTION

The present invention relates to an articulated bushing chain comprising inner and outer chain links alternately connected to one another by means of a chain joint, the inner chain link comprising at least one inner plate and two joint bushings and the outer chain link comprising at least two outer plates and two joint pins interconnecting the same, each chain joint being defined by a joint bushing of the inner chain link and a joint pin of the outer chain link and the chain joint being configured as a rocker joint in which a rocking surface of the joint pin rolls on a convex inner rocker contour of the joint bushing during a movement of the joint.

### BACKGROUND

This kind of articulated bushing chain is known e.g. from U.S. Pat. No. 5,176,587. Such an articulated bushing chain is primarily intended for use in e.g. timing chain drives of internal combustion engines. Such chain drives operate under extreme load conditions and are therefore subjected to substantial wear and high dynamic loads. The chain described comprises alternate inner chain links and outer chain links. The inner chain link consists of two parallel inner plates interconnected by two spaced-apart joint bushings. The joint bushings are deformed on one side thereof so that they are kidney-shaped in cross-section, whereby an internally directed convex rocker contour is formed on the inner side. Each outer chain link consists of two spaced-apart outer plates interconnected by means of two spaced-apart joint pins. Each of these joint pins extends through the opening of a joint bushing of a neighboring inner chain link and has a cross-section which deviates substantially from a circular shape and which has a convex rocker shape. The rocking surface of the joint pin comes into contact with the rocker contour of the associated joint bushing. During pivoting of the chain, especially during engagement with and disengagement from a chain wheel, the rocking surface is here intended to roll on the rocker contour. Such rocker joints cause substantially less friction than conventional articulated chains with cylindrical joint pins and joint bushings. Such articulated bushing chains have, however, been pure theory up to now, and none of these articulated bushing chains has been realized in practice for a timing chain drive. The reason for this was that, in spite of the theoretically lower friction power, the service life of such chains proved to be insufficient.

### SUMMARY OF THE INVENTION

It is therefore the object of the present invention to provide an articulated bushing chain of the type specified at the beginning, which has an improved service life. The present invention achieves this object for an articulated bushing chain of the type in question by providing the rocking surface of the joint pin with a rocking radius which is larger than the limit value G calculated according to the following formula:

$$G = \frac{arctan {μ}_{sf} - \frac{2 π}{z}}{\frac{2 π}{z \cdot {p}_{ol}} - \frac{arctan {μ}_{sf}}{{R}_{bushing}}}$$

wherein R_{bushing} corresponds to the rolling radius of the bushing in millimeters,
z corresponds to an integer with a value of ≦24,
pₒₗ, which stands for p_{outer chain link}, corresponds to the pitch of the outer chain link in millimeters and
μ_{sf}, which stands for μ_{static friction}, corresponds to the coefficient of static friction of the joint pin and the joint bushing.

The inventors discovered that a rocker joint consisting of a joint bushing and a joint pin may, in principle, cause a substantial reduction of friction, but that especially if chain wheels having a comparatively small number of teeth are used—and the use of such chain wheels is nothing out of the common in timing chain drives—a hitherto undiscovered effect occurs. Due to the fact that the chain moves into engagement with a chain wheel, the front chain link pivots relative to the subsequent chain link. When two convex rocker joint areas, which roll on one another, have a conventional structural design, transverse forces will be created, which, in the worst case (i.e. when the static friction limit value is exceeded), lead to slipping of the joint pin relative to the joint bushing. The inventors additionally discovered that the radii of the rocking surfaces of the joint pin and of the rocker contour of the joint bushing are very important. It goes without saying that also the combination of joint pin material and joint bushing material is of importance, a circumstance which finds expression in the coefficient of static friction. In addition, this formula takes into account, via the pitch pₒₗ of the outer chain links, the migration of the contact point in relation to this pitch pₒₗ. As regards the design the widest scope exists with respect to the rocking radius of the joint pin, since the bushing is subjected to higher restrictions due to its inner contour. Tests have shown that the rocking surface of the joint pin should be configured such that it has the largest possible rocking radius, which is normally substantially larger than hitherto known, frequently used rocking radii of such joint pins. Due to the fact that particularly large radii (positive or negative) prove to be advantageous, especially a straight shape of the rocking surface of the joint pin, i.e. a rocking radius of co, will be suitable as a special form. This special form is, in principle, already known from EP 0563362 B1 for other chain types and rocker joint configurations without a joint bushing. The chain described there is, however, configured as a tooth chain, which is regarded as having been improved insofar as two joint pins rolling on one another, which were used in previous versions of such tooth chains, are no longer used, but one joint area is now defined by the opening of a plate and the other one by a joint pin. U.S. Pat. No. 5,176,587, which aimed at creating a new type of rocker joint without a second joint pin, started from a similar situation. Although EP 0563362 B1 refers to use in a timing drive as at least one of the possible cases of use, the use of such chains for chain drives having a number of teeth ≦24 is not known in practice. Insofar the negative effect which may be caused by slippage of a joint pin relative to a joint bushing has not been realized, since, in practice, this effect does not occur at all in connection with chain wheels having a comparatively large number of teeth.

When, in accordance with the present invention, larger radii adapted to the influencing factors are used for the rocking surface of the joint pin, the joint pin will be prevented from slipping on the joint bushing, whereby friction power will be reduced substantially, which will also lead to a substantial reduction of wear. In comparison with an identically sized bushing chain with cylindrical joint pins and a cylindrical joint bushing, the friction power can be reduced at least by a factor of 5. In comparison with an articulated bushing chain of the type shown in U.S. Pat. No. 5,176,587, in the case of which lateral slippage will take place, a reduction by a factor of approximately 2.5 is still possible. These values show that the embodiment according to the present invention has an enormous potential for savings in an order of magnitude which can nowadays be achieved only rarely in developments taking place in the automotive sector and concerning internal combustion engines.

Further to the above it should here also be pointed out that the bushing chain may also be configured as a roller chain in which the joint bushing has additionally arranged thereon a rotatably supported roller. The values used for the rocking radius are preferably positive values, slightly concave shapes (when the radius is negative) will, however, work as well. It is only necessary that the rocking radius and the rolling radius of the bushing are provided in the here specified size in the respective joint surface area participating in the movement of the joint. It is also imaginable that the rocking radius value and the rolling radius value of the bushing vary, as long as the limit value is taken into account in the effective region. Especially in the case of slightly concave shapes of the rocking surface of the joint pin, the value of the rocking radius should preferably be larger than 8 times pₒₗ so as to guarantee the low-friction function of the rocker joint.

According to an embodiment, the limit value G may, for convex rocking surfaces, be larger than pₒₗ, preferably larger than twice pₒₗ or 4 times pₒₗ, and more preferably larger than 8 times pₒₗ and/or for concave rocking surfaces the value of the limit value G may be larger than 8 times pₒₗ. In the transition range z between convex and concave rocking surfaces, a straight rocking surface (limit value G=∞) exists, which is here intended to be included. The fulfillment of these minimum requirements is relevant, in particular for concave rocking surfaces, since a chain joint that is capable of operating can otherwise not be guaranteed for all numbers of teeth, combinations of materials, etc. For the normally used standard pitches and the normally used combinations of materials as well as for realistic rolling radii R_{bushing} of the inner rocker contour this is, however, guaranteed by the formula.

It will be advantageous when the rolling radius of the rocker contour of the joint bushing lies in the range of 0.125 to 0.625×pₒₗ, preferably 0.25 to 0.5×pₒₗ, and more preferably 0.3 to 0.4×pₒₗ. It turned out that advantageous strength conditions occur in this range. On the one hand, the Hertzian stress must be taken into account, which must not become excessively high, and, on the other hand, a certain radius must not be exceeded, since otherwise said radius can no longer find reasonable expression in the inner contour of the joint bushing.

The value z should preferably lie in a range of 16 to 24, more preferably in a range of 17 to 23. Normally, it will be endeavored to use, for reasons of installation space, the smallest possible crankshaft chain wheel e.g. for timing drives in internal combustion engines. Due to the substantial pivoting of the chain joints, small numbers of teeth are always problematic. The present invention effectively provides a structural measure for restricting wear within the chain joint also in the case of small numbers of teeth. Reducing the number of teeth still further does normally not make sense with respect to the more and more increasing polygon effect, and, consequently, the above ranges are to be regarded as the preferred range of application of the present invention. Such articulated bushing chains are always configured with respect to the drive intended to be used, and, consequently, also the number of teeth of the smallest chain wheel has here a decisive influence on the structural design of the chain. This is taken into account by the value z.

According to advantageous embodiments the rocking surface of the joint pin may either have a convex curved shape or it may be plane in shape as a limit value of the largest curvature. The convex curvature offers especially possibilities of optimization with respect to the rolling conditions. The plane embodiment represents a solution which, in the preferred teeth number range, prevents, in view of the resultant relationship of forces, the transverse force from exceeding the static friction force in most cases of use. This is due to the fact that the plane rocking surface always abuts tangentially on the convex inner rocker contour of the joint bushing and that the optimum of smallest possible transverse forces is thus approximated very well by a plane rocking surface. In addition, a plane surface is easy to produce.

According to an advantageous embodiment, the coefficient of static friction μ_{sf} lies in the range of 0.1 to 0.15. For the material combination steel on steel, the coefficient of static friction lies at 0.12. Therefore, the joint pin and the joint bushing are preferably each made of a steel material. This leads to high strengths in combination with low costs.

According to an embodiment, the joint bushing may have a cylindrical outer circumferential surface and its wall thickness may vary at least over a subarea of the circumference so as to form the inner rocker contour. Such bushings can be produced e.g. by extrusion or an MIM process (Model Injection Molding) or sintering. A cylindrical outer circumferential surface additionally leads to a uniform distribution of stress in the associated inner plate.

The invention additionally relates to the use of an articulated chain in a fast-running chain drive, preferably a timing chain drive, comprising at least one chain wheel having a number of teeth z≦24, wherein the articulated chain comprises alternating inner and outer chain links connected to one another by means of a chain joint, each chain joint is defined by a joint opening of the inner chain link and a joint pin of the outer chain link, and the chain joint is configured as a rocker joint in which the rocking surface of the joint pin rolls on a convex inner rocker contour of the joint opening during a movement of the joint, and wherein the rocking surface of the joint pin has a rocking radius which is larger than the limit value G calculated according to the following formula:

$$G = \frac{arctan {μ}_{sf} - \frac{2 π}{z}}{\frac{2 π}{z \cdot {p}_{ol}} - \frac{arctan {μ}_{sf}}{{R}_{o}}}$$

wherein Rₒ corresponds to the rolling radius of the joint opening in millimeters,
pₒₗ corresponds to the pitch of the outer chain link in millimeters and
μ_{sf} corresponds to the coefficient of static friction of the joint pin and the joint opening.

The joint pin can thus roll directly on the joint opening. A joint bushing is not absolutely necessary. The use of such a chain in a fast-running chain drive including a small chain wheel with a number of teeth ≦24 has hitherto not been described in the prior art and is not obvious with respect to the resultant prevention of slippage of the joint pin on the rocker contour of the joint opening.

In this respect it should also be taken into consideration that, especially in the case of tooth chains, guidance may be given on the chain wheel due to tooth engagement on said chain wheel, which may take place on the inner as well as on the outer side, said guidance preventing, in principle, a lateral displacement of the joint pin and of the joint opening relative to one another in the transverse direction.

The invention additionally relates to a chain drive comprising at least two chain wheels and an articulated bushing chain according to one of the claims 1 to 7, wherein at least one chain wheel has a number of teeth ≦24.

### BRIEF DESCRIPTION OF THE DRAWINGS

In the following, an embodiment of the present invention will be described in more detail making reference to a drawing, in which:

FIG. 1 shows a front view of a chain drive according to the present invention, the chain being shown in a schematic full section view,

FIG. 2 shows an enlarged representation of a part of the articulated bushing chain according to the present invention in a front view,

FIG. 3 shows the articulated bushing chain according to FIG. 2 in a top view,

FIG. 4 shows the articulated bushing chain according to FIG. 3 in a full section view, only one inner chain link and one outer chain link being shown,

FIG. 5 shows an inner chain link of the chain according to FIG. 3 in an enlarged top view,

FIG. 6 shows an outer chain link of the chain according to FIG. 3 in an enlarged top view,

FIG. 7 shows an articulated bushing chain which does not correspond to that according to the present invention in a full section view,

FIG. 8 shows, in an enlarged representation, the articulated bushing chain according to FIG. 7 just moving into engagement with a chain wheel,

FIG. 9a, 9b, 9c show the process in which the chain according to FIG. 7 moves into engagement with a chain wheel, with the joint pin slipping,

FIG. 10 shows a chart representing a comparison between various types of joints of an articulated bushing chain.

### DETAILED DESCRIPTION

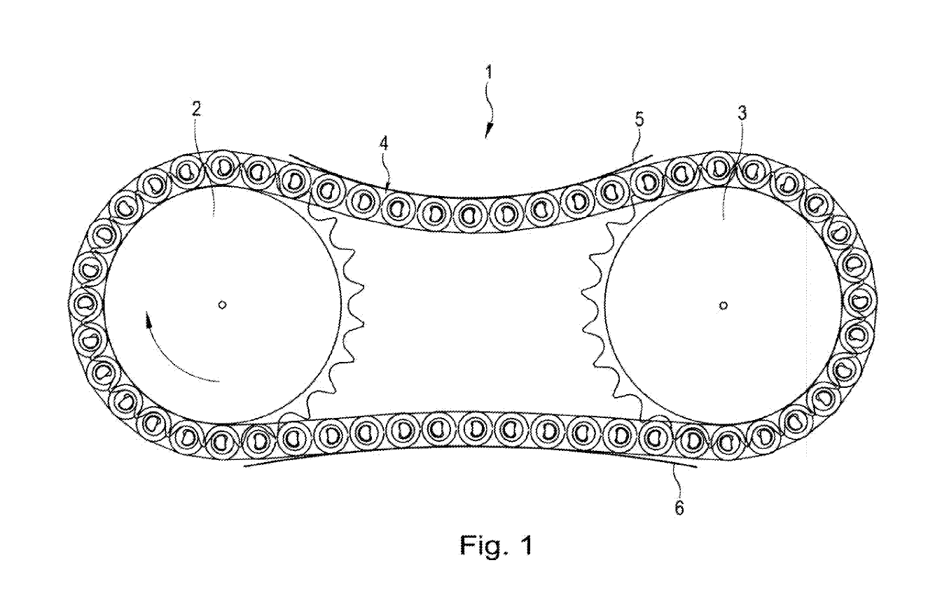

The chain drive 1 shown in FIG. 1 is only an exemplarily shown chain drive in which the two chain wheels 2, 3 are identical in size, i.e. provided with an identical number of teeth (here 24). The endlessly joined articulated bushing chain 4 wrapped around the chain wheels 2, 3 may just as well be used in a timing chain drive of an internal combustion engine with a crankshaft chain wheel and e.g. two overhead camshaft chain wheels. By means of the circular arcs 5 and 6, a tensioning rail as well as a guide rail are schematically indicated, such rails being in principle very well known, especially for timing chain drives. The circular arc 6 symbolizes the guide rail, along which the tight span of the articulated bushing chain 4 slides, and the circular arc 5 symbolizes a tensioning rail sliding along the slack span of the articulated bushing chain 4. The chain wheel 2 is the driving chain wheel which rotates clockwise.

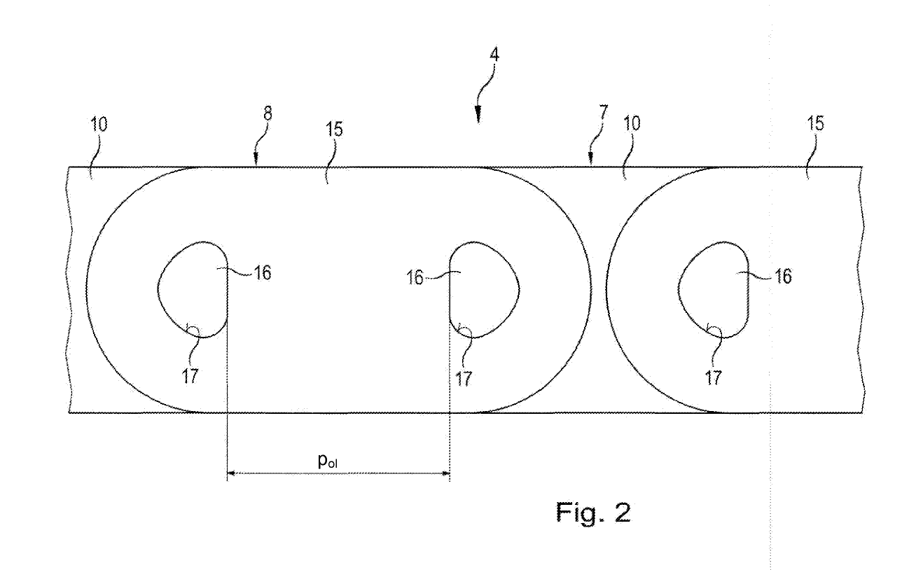

Making reference to FIGS. 2 to 6, the structural design of the articulated bushing chain 4 used will now be explained in more detail. The articulated bushing chain 4 comprises alternately arranged inner and outer chain links 7 and 8, the respective chain links being connected to one another via a chain joint 9. The inner chain link 7 consists of two inner plates 10, which are spaced-apart in parallel, and of two spaced-apart joint bushings 11 interconnecting these inner plates 10. To this end, each inner plate 10 includes two spaced-apart cylindrical openings 12 into which the joint bushings 11 configured with a cylindrical circumferential surface are pressed. The joint bushings 11 slightly project laterally beyond the outwardly directed faces of the inner plates 10. The distance between the joint bushings 11 is chosen such that the tooth of a chain wheel can engage therebetween. The joint bushings 11 exhibit a center-to-center distance which corresponds to the pitch pₙ (in the present case 8 mm). The pitch pₙ (measured at the pitch circle) corresponds to the normal pitch. This pitch has to be differentiated from chain link pitches, which are related to the chain joint 9, viz. the pitch pᵢₗ for the inner chain link 7, pᵢₗ stands for p_{inner chain link}, and the pitch pₒₗ for the outer chain link 8, pₒₗ stands for p_{outer chain link}. The joint opening 13 of the joint bushings 11 is substantially bean- or kidney-shaped in cross-section. Since the articulated bushing chain 4 is intended to pivot in both directions with its chain joint 9, the joint opening 13 is configured symmetrically with respect to the longitudinal axis Lₗ of the inner chain link 7. On the respective joint opening side located closer to the ends of the inner chain link 7, the joint opening 13 is provided with a respective convex rocker contour 14, which is also configured symmetrically with respect to the longitudinal axis Lₗ. The radius R_{bushing} of the rocker contour 14 is 2.7 mm in the present case. The respective rocker contour 14 is provided such that, relative to the center of the joint bushings 11, it is laterally displaced in the direction of the ends of the inner chain link 7.

Each outer chain link 8 consists of two parallel spaced-apart outer plates 15 and of two spaced-apart joint pins 16 interconnecting these outer plates 15. The joint pins 16 are arranged at a pitch pₒₗ and pressed into adequately shaped openings 17 in the outer plates 15. The ends of the joint pins 16 project beyond the outer surface of the outer plates 15. The cross-sectional shape of the joint pins 16 could be referred to as a flattened kidney without any recessed area. The rocking surface 18 of the present embodiment is configured as a plane surface and extends thus perpendicular to the longitudinal axis L_{A} of the outer chain link 8. The other sides are formed by adjoining circular segments. The joint pin 16 is arranged symmetrically to the longitudinal axis L_{A}, so that the same cross-sectional subareas are provided above as well as below this axis. The cross-sectional areas of the joint pin 16 and of the joint opening 13 are adapted to one another such that the joint pin 16 can pivot within the joint opening 13 in that its rocking surface 18 rolls on the convex rocker contour of the associated joint bushing 11.

All the parts of the articulated bushing chain 4 are made of a steel material.

The pitch p_{H} of the inner chain link 7 and the pitch pₒₗ of the outer chain link 8 may be identical or different, e.g. for reasons of strength. In the present case, the pitch pᵢₗ is 8.5 mm and the pitch pₒₗ is 7.5 mm. The rocking surface 18 has a radius of ∞ due to its straight shape. Hence, the structural design in the preferred range of use fulfils in any case the predetermined limit value G, which the radius R_{B} of the rocking surface 18 should have. This limit value G is calculated according to the following formula:

$$G = \frac{arctan {μ}_{sf} - \frac{2 π}{z}}{\frac{2 π}{z \cdot {p}_{ol}} - \frac{arctan {μ}_{sf}}{{R}_{bushing}}}$$

wherein G corresponds to the smallest admissible rolling radius of the rocking surface 18,
R_{bushing} corresponds to the rolling radius of the rocker contour 14,
z corresponds to the number of teeth of the smallest chain wheel in the chain drive,
pₒₗ corresponds to the pitch of the outer chain link and
μ_{sf} corresponds to the coefficient of static friction of the joint pin and the joint bushing.
In the case of a steel/steel combination of the rocker joint 9, μ_{sf} is 0.12.

In this context, it should be pointed out that the formula is an approximation, which, however, provides very good values in practice. On the basis of the table following hereinbelow, it will be exemplarily shown for the numbers of teeth 18 to 24, which smallest admissible limit values G for rolling radii R_{B} result from this formula.

| Z | R_{bushing} | pₒₗ | μ_{sf} | G |
|---|---|---|---|---|
| 18 | 2.7 | 7.5 | 0.12 | −99.4 |
| 19 | 2.7 | 7.5 | 0.12 | 1504.7 |
| 20 | 2.7 | 7.5 | 0.12 | 83.0 |
| 21 | 2.7 | 7.5 | 0.12 | 41.4 |
| 22 | 2.7 | 7.5 | 0.12 | 27.0 |
| 23 | 2.7 | 7.5 | 0.12 | 19.7 |
| 24 | 2.7 | 7.5 | 0.12 | 15.3 |

This kind of chain is primarily intended to be used in a timing chain drive. A timing chain drive is a highly dynamic, fast running chain drive in which the crankshaft rotates in an rpm range of up to several 1,000 revolutions per minute. Insofar, the friction conditions in the chain joint 9 are of decisive importance. In addition, there are increasing endeavors to reduce the CO₂ emission of internal combustion engines to the lowest possible value, and improvements of the friction power of individual components are therefore very important. The rocker joint 9 used in the articulated bushing chain 4 shown already results, in comparison with a normal articulated bushing chain comprising cylindrical joint pins and an associated joint bushing, in a more than fivefold reduction of friction power (the number of teeth z being here 24 and the number of revolutions 1,000 rpm) for a chain having the same size.

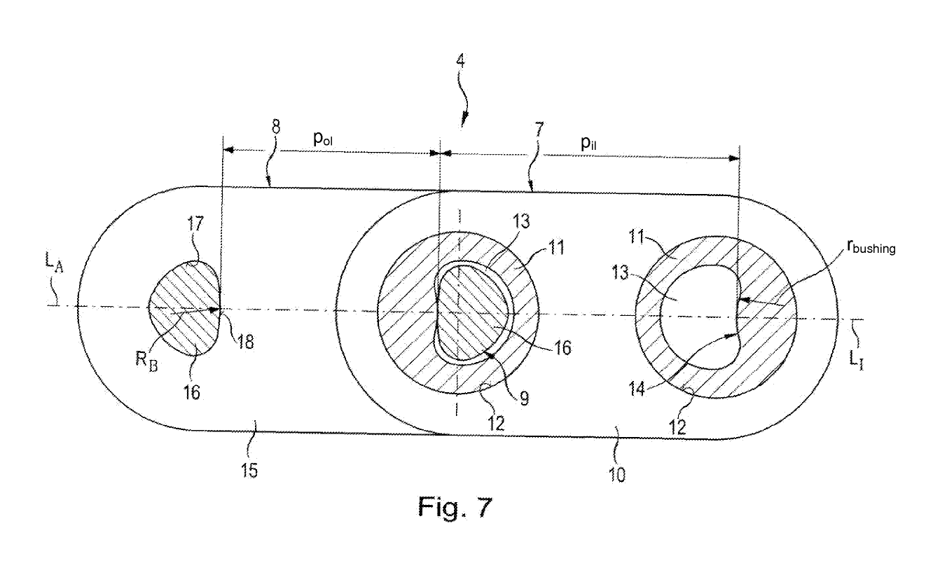

Making reference to FIGS. 7 to 9c, the principle of the present invention will now be explained in more detail on the basis of an articulated bushing chain which is different from that according to the present invention.

The only difference with respect to the articulated bushing chain 4 shown in FIG. 7 is that the rocking surface 18 of the joint pin 16 is convex with a radius R_{B}, which does not fulfill the criterion of the above formula, but is smaller than the theoretically calculated limit value G. The reference numerals used for FIGS. 7 to 9c correspond to those used for the above articulated bushing chain and the above chain drive, so that reference is additionally made to the structural design and the mode of operation of the above articulated bushing chain 4 and chain drive 1.

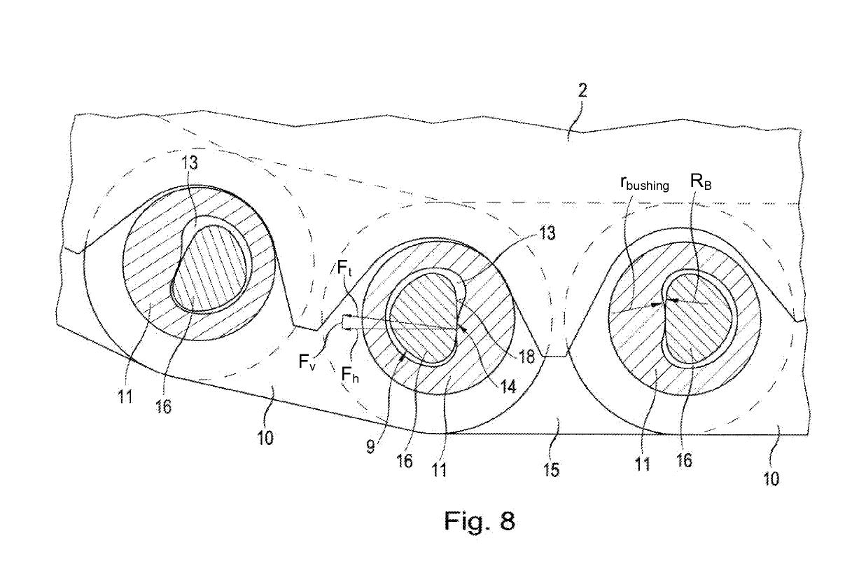

FIG. 8 shows the process in which the articulated bushing chain according to FIG. 7 moves into engagement with the chain wheel 2. The fully shown outer chain link 8 still occupies a horizontal, tangential position, whereas the preceding inner chain link 7 has already been engaged by the teeth of the chain wheel 2 and bends. The bending angle α is 15° for a chain wheel 2 having a number of 24 teeth. The bending movement or pivoting movement has the effect that the rocker contour 14 of the lower joint bushing 11 rolls on the convex rocking surface 18 of the joint pin 16.

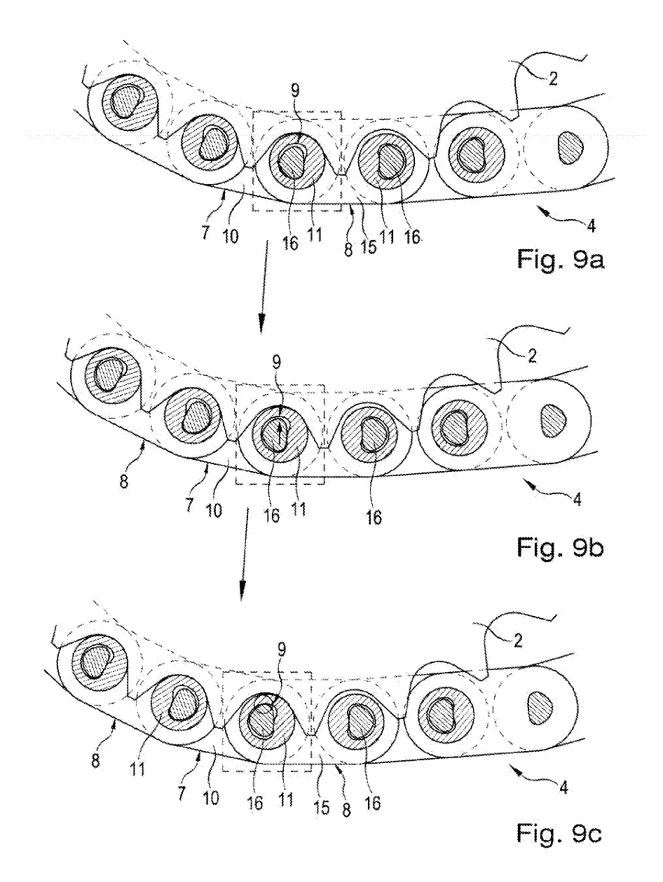

At the position shown, the force Fₜ transmitted between the joint bushing 11 and the joint pin 16 is perpendicular to the tangent surface between the two elements. When a triangle of forces is now included in the drawing, the force Fₜ is divided into a horizontal force component Fₕ and a vertical force component Fᵥ. In the present case, the force component Fᵥ exceeds, however, the static friction of the two joint partners. In view of the fact that the joint pin 16 is arranged with a certain amount of play in the joint opening 13, the whole outer chain link 8 can now slip upwards in the front area, since only the inner chain link is engaged by the teeth of the chain wheel 2. A sliding movement of the rocking surface 18 along the rocker contour 14 will thus occur. This process is illustrated very well by FIGS. 9a to 9c. The moment at which the slipping movement starts is shown in FIG. 9b. The joint pin 16 slips upwards and may in extreme cases strike against the joint opening 13 with its upper round edge, as shown in FIG. 9c. In order to make things clearer, the chain joint 9 to be viewed is enclosed by a dashed square.

This slipping process leads to a quite a considerable friction power and, in the final analysis, to wear of the chain joint 9. This may be the reason for the fact that attempts to use rocker joints in timing chain drives, in which chain wheels having a comparatively small number of teeth may be comprised, have largely failed up to now.

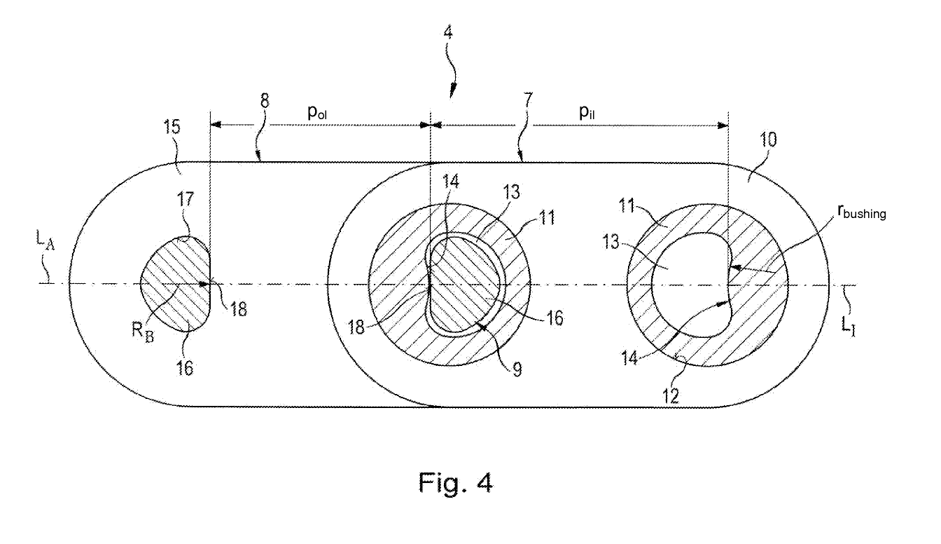

Other than the above rocking surface, a straight or flat rocking surface 18 of the type shown in FIG. 4 will always have the effect that the resultant force acts perpendicularly onto the rocking surface 18 of the joint pin 16 and that thus no force component directed substantially radially to the center of the chain wheel 2 will be created. However, even small vertical force components are harmless as long as they do not exceed the static friction of the two joint partners. This is guaranteed by the above formula. If the radius R_{B} of the rocking surface 18 becomes smaller than the limit value G, this disadvantageous slippage effect will occur. If the radius lies within the range above the calculated limit value G, the static friction will be higher and slippage will be prevented. The formula includes a reference to the pitch pₒₗ. In this way it is taken into account that the contact point migrates when the outer chain link 8 pivots and that the pitch pₒₗ measured in the straight condition of the articulated bushing chain 4 varies slightly.

In principle, the use of chains including a rocker joint having this kind of structural design for chain drives with chain wheels whose number of teeth is ≦24 has not been described previously, in particular not with respect to the possibly arising problems.

It is definitely possible to design such a rocker joint as a direct matched pair comprising a joint pin and a plate opening. The rocker contour of such a plate opening has then the radius Rₒ.

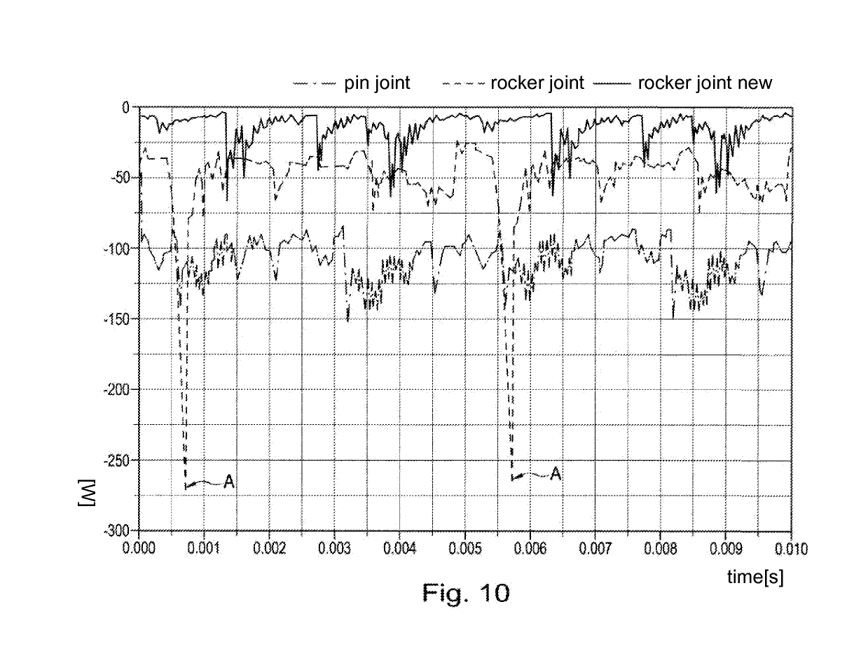

On the basis of FIG. 10, the friction power is plotted against time with respect to the chain drive shown in FIG. 1 (including the chain wheels 2 and 3 and a number of teeth of 24) at a revolution speed of 1,000 rpm. The lines show the profile of the friction power in watt within 0.010 seconds. This is essentially the time in which two inner chain links 7 and two outer chain links 8 move into engagement with a chain wheel 2 in the case of this number of revolutions. The friction power for an articulated bushing chain 4 with a rocker joint of the type shown in FIG. 4 is indicated by the upper solid line.

The lower dot-and-dash line shows in comparison thereto an articulated bushing chain of identical size with cylindrical joint pins and associated joint bushings. It turns out that the friction power is much higher, the fluctuations being, however, not much larger than those in the case of the articulated bushing chain according to FIG. 4.

A different situation occurs in the case of the dashed line. The chain is here an articulated bushing chain which does not correspond to that according to the present invention and which is shown in FIG. 7. An extreme outlier A in the friction power can here clearly be seen in the range between 0.0005 and 0.001 seconds as well as in the range between 0.0055 and 0.006 seconds. Although the curve generally moves mainly between the dot-and-dash line and the solid line, the outliers A indicate that high peak loads occur in the chain joint 9. These outliers A show that the joint pin 16 slips along the joint bushing 11, as has been explained according to FIGS. 9a to 9c. Such slippage will normally occur only in the case of every second chain joint 9 while the chain is moving into engagement with the chain wheel 2, and it will occur in the case of the chain joint 9 in which the inner chain link 7 precedes (i.e. bends first), but not in the trailing chain joint 9 in which the outer chain link 8 precedes (i.e. bends first).

The diagram also shows that a straight or plane rocking surface 18 proves to be a particularly advantageous special case, since this embodiment creates a chain which always fulfills the limit value G according to the above formula, at least in the normal tooth plate region in timing chain drives. Moreover, due to optimized rolling conditions (improvement of Hertzian stress etc.), the friction power can be improved even in comparison with a rocker joint in which convex rocking partners roll on one another.

Hence, the invention presented here will, when used in an internal combustion engine, contribute to a substantial reduction of the CO₂ emission of the internal combustion engine.

### LEGEND OF THE FIGURES

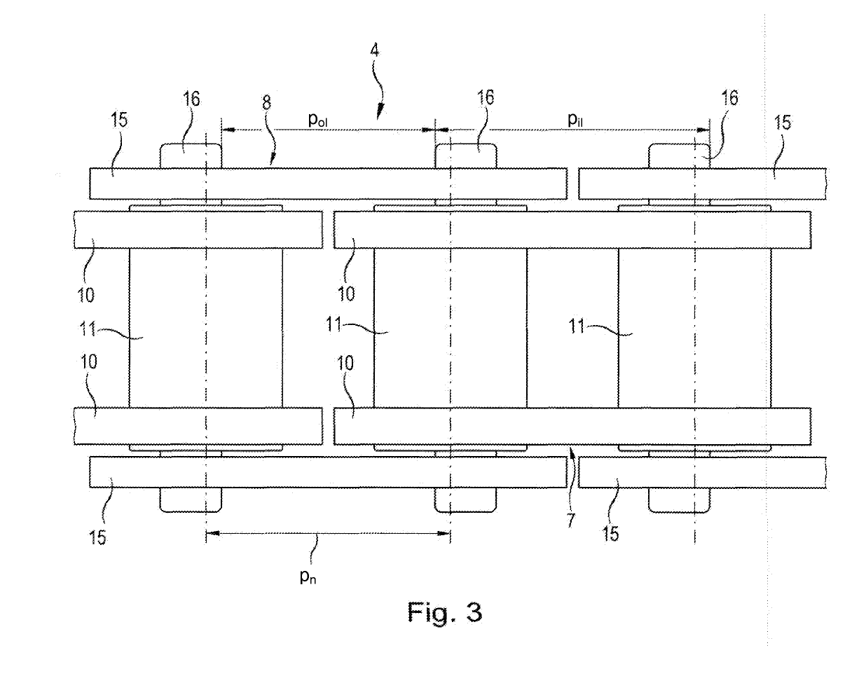

### FIG. 3

p_{AG}=pₒₗ
p_{IG}=pᵢₗ
p_{N}=pₙ

### FIG. 4

p_{AG}=pₒₗ
p_{IG}=pᵢₗ
R_{Hülse}=r_{bushing}

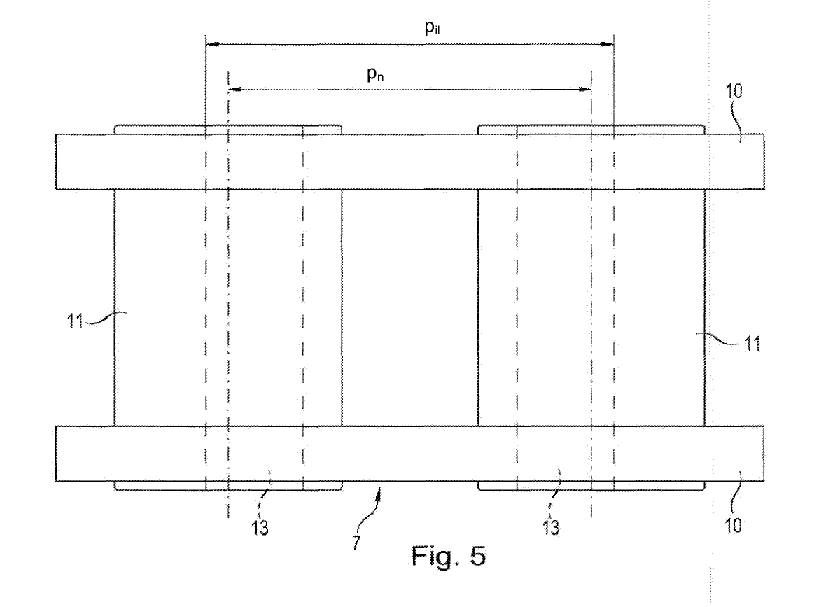

### FIG. 5

p_{IG}=pᵢₗ
p_{N}=pₙ

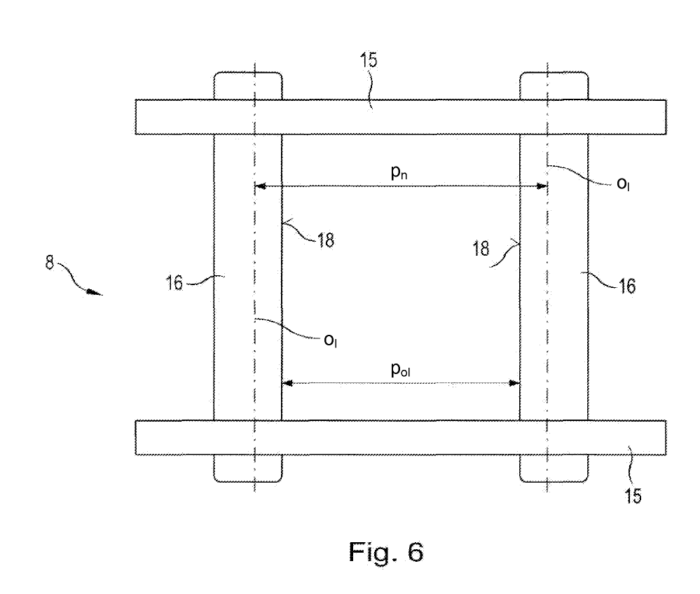

### FIG. 6

p_{AG}=pₒₗ
p_{N}=pₙ
A_{G}=oₗ

### FIG. 7

p_{AG}=pₒₗ
p_{IG}=pᵢₗ
R_{Hülse}=r_{bushing}

### FIG. 8

F_{Ü}=Fₜ
F_{V}=Fᵥ
F_{H}=Fₕ
R_{Hülse}=r_{bushing}
R_{B}=R_{B}

### FIG. 10

Bolzengelenk=pin joint
Wiegegelenk=rocker joint
Wiegegelenk Neu=rocker joint new
[W]=[W]
Zeit[s]=time[s]
A=A

1. An articulated bushing chain comprising inner and outer chain links alternately connected to one another by means of a chain joint, the inner chain link comprising at least one inner plate and two joint bushings and the outer chain link comprising at least two outer plates and two joint pins interconnecting the same, each chain joint being defined by a joint bushing of the inner chain link and a joint pin of the outer chain link and the chain joint being configured as a rocker joint in which a convex curved rocking surface of the joint pin rolls on a convex inner rocker contour of the joint bushing during a movement of the joint, wherein the convex curved rocking surface of the joint pin has a rocking radius which is larger than the limit value G calculated according to the following formula:
$$G = \frac{arctan {μ}_{sf} - \frac{2 π}{z}}{\frac{2 π}{z \cdot {p}_{ol}} - \frac{arctan {μ}_{sf}}{{R}_{bushing}}}$$
wherein R_{bushing} corresponds to the rolling radius of the joint bushing in millimeters,
z corresponds to an integer ≦24,
pₒₗ corresponds to the pitch of the outer chain link in millimeters,
μ_{sf} corresponds to the coefficient of static friction of the joint pin and the joint bushing.

2. The articulated bushing chain according to claim 1, wherein for convex rocking surfaces the limit value is larger than pₒₗ, preferably larger than twice pₒₗ or 4 times pₒₗ, and more preferably larger than 8 times pₒₗ.

3. The articulated bushing chain according to claim 1, wherein the rolling radius of the inner rocker contour of the joint bushing lies in the range of 0.125 to 0.625×pₒₗ, preferably 0.25 to 0.5×pₒₗ, and more preferably 0.3 to 0.4×pₒₗ.

4. The articulated bushing chain according to claim 1, wherein z lies in the range of 16 to 24, preferably in the range of 17 to 21.

5. The articulated bushing chain according to claim 1, wherein that μ_{sf} lies in the range of 0.1 to 0.15.

6. The articulated bushing chain according to claim 5, wherein the joint pin and the joint bushing are each made of a steel material.

7. The articulated bushing chain according to claim 1, wherein the joint bushing has a cylindrical outer circumferential surface and that its wall thickness varies at least over a subarea of the circumference so as to form the inner rocker contour.

8. The use of an articulated chain in a fast-running chain drive, preferably a timing chain drive, comprising at least one chain wheel having a number of teeth z≦24, wherein the articulated chain comprises alternating inner and outer chain links connected to one another by means of a chain joint, and each chain joint is defined by a joint opening of the inner chain link and a joint pin of the outer chain link, and the chain joint is configured as a rocker joint in which the convex curved rocking surface of the joint pin rolls on a convex inner rocker contour of the joint opening during a movement of the joint, wherein the convex curved rocking surface of the joint pin has a rocking radius which is larger than the limit value G calculated according to the following formula:
$$G = \frac{arctan {μ}_{sf} - \frac{2 π}{z}}{\frac{2 π}{z \cdot {p}_{ol}} - \frac{arctan {μ}_{sf}}{{R}_{o}}}$$
wherein Rₒ corresponds to the rolling radius of the joint opening in millimeters,
pₒₗ corresponds to the pitch of the outer chain link in millimeters, and
μ_{sf} corresponds to the coefficient of static friction of the joint pin and the joint opening.

9. A chain drive comprising at least two chain wheels and an articulated bushing chain according to claim 1, wherein at least one chain wheel has a number of teeth ≦24.
